(19) United States
(12) Patent Application Publication
(10) Pub. No.: US 2023/0243790 A1
(43) Pub. Date: Aug. 3, 2023

(54) MACHINE LEARNING TECHNIQUES FOR DISCOVERING ERRORS AND SYSTEM READINESS CONDITIONS IN LIQUID CHROMATOGRAPHY INSTRUMENTS

(71) Applicant: Waters Technologies Ireland Limited, Dublin (IE)

(72) Inventor: Marisa Gioioso, Hopkinton, MA (US)

(73) Assignee: Waters Technologies Ireland Limited, Dublin (IE)

(21) Appl. No.: 18/163,451

(22) Filed: Feb. 2, 2023

Related U.S. Application Data
(60) Provisional application No. 63/305,867, filed on Feb. 2, 2022.

(51) Int. Cl. G01N 30/86

(52) U.S. Cl. CPC G01N 30/8693; G01N 2030/027

(57) ABSTRACT

Various machine learning techniques can detect errors (e.g., leaking valves, column plugging) and other conditions (e.g., system readiness conditions like equilibration and priming) in LC devices. Examples of suitable AI/ML models include Bayesian hierarchical models, gradient boosted trees, and recurrent neural networks. Embodiments have shown expert-level identification of conditions based on a limited amount of signals data from the instrument (about 2 minutes' worth of data).

### CROSS-REFERENCE TO RELATED APPLICATIONS

This application claims the benefit of and priority to U.S. Provisional Patent Application No. 63/305,867, filed Feb. 2, 2022. The entire disclosure of which is hereby incorporated by reference.

### BACKGROUND

Mass spectrometry (MS) and liquid chromatography-mass spectrometry (LCMS) apparatuses are used to analyze a chemical sample to study the identity, mass, or structure of the sample. Such systems are made up of a number of parts and subsystems, each of which may be associated with errors (e.g., leaking valves, failed pumps, etc.) or system readiness conditions (e.g., equilibration, priming, etc.). These systems may provide output signals (such as a pressure signal) that can be analyzed by experts in order to detect the errors or readiness conditions. This is, however, a time consuming process that requires that the expert be present in order to review the data. Moreover, it is a subjective process and different experts may detect the errors/readiness conditions in the same data at different times.

For example, LC users must have a lot of knowledge of normal and abnormal status and operation of an LC device. Except for some simple (and not widely used) indicators, the user must understand and identify when the instrument is in one of the following states:
Primed
Equilibrated
Check valve leak
Pressure seal leak
Degasser failure
Clogged inject valve
Partially clogged needle
Fouled column
Column is chemically and thermally equilibrated
Detector is stable and not drifting

In some cases, there are existing system checks to detect these states, but they are either not run by the user or take too long. In other cases, it is left up to the user to either identify and resolve the problems, or at least know that something is not right and to call a service engineer. This results in lower customer satisfaction due to higher downtime when parts fail, and longer experiment times because of the skill and maintenance required from the user. In some cases, a novice user may not know the system is in an error state and proceed to collect questionable data.

Similarly, although the service specialists are highly trained, they have varying levels of experience with each of these issues and/or on some instruments but not others. Because of this, and a lack of easily human interpretable diagnostics, parts are replaced that work fine while they troubleshoot the root of a problem. This results in higher costs for the company and waste. Accurate, fast, and easy to interpret diagnostics can greatly improve service efficiency.

### BRIEF SUMMARY

Exemplary embodiments relate to computer-implemented methods for constructing and training artificial intelligence/machine learning (AI/ML) models that will identify failure states and readiness conditions based on time series signal values and/or experimental result data, and predict when failures might occur in the future. Embodiments also pertain to non-transitory computer-readable mediums storing instructions for performing the methods, apparatuses configured to perform the methods, etc.

Models generated by these techniques may be generalized to solve many different problems. For example, one embodiment may predict a column plugging condition. A user may queue a number of injections (e.g., 50) to run over a period of time (e.g., overnight). Exemplary embodiments may be able to predict error conditions and therefore warn the user that the instrument may only be able to perform a subset of the injections (e.g., the first 20) before an error condition prevents the instrument from continuing.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an aspect of the subject matter in accordance with one embodiment.

FIG. 1B illustrates an aspect of the subject matter in accordance with one embodiment.

FIG. 2 illustrates an exemplary artificial intelligence/machine learning (AI/ML) system suitable for use with exemplary embodiments.

FIG. 3 depicts an illustrative computer system architecture that may be used to practice exemplary embodiments described herein.

FIG. 4 illustrates an example of a mass spectrometry system according to an exemplary embodiment.

FIG. 5 is a flowchart depicting an exemplary method for detecting system readiness/error conditions in accordance with exemplary embodiments.

### DETAILED DESCRIPTION

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

### Exemplary Embodiments

Exemplary embodiments may generally follow the following steps.

### Generate Failure Data

Controlled data sets may be generated that exhibit normal behavior and also abnormal, suboptimal or fully failed behavior. This may involve swapping out working parts on a test liquid chromatograph (LC) with failed parts retrieved from the field and running injections with the failed parts, or retrieving data from previous abnormal, suboptimal, or fully failed user analyses.

For example, a data collection user may perform installations of faulty parts, and run various kinds of injections to represent a wide range of chemistries, columns, ambient temperatures and other exogenous variables that influence the time traces.

Examples of data sets implicating abnormal or system ready conditions include, but are not limited to:
Equilibration data, for which chromatogram data and pressure traces may be collected; the system may check for chemical and thermal equilibration
Pressure traces indicating that the LC device has undergone a loss of prime condition; pressure traces may be collected showing loss of prime under a variety of different situations
Check valve leak data
Pressure seal leak data
Degasser failure data
Clogged inject valve data
Partially clogged needle data
Fouled column data
Detector stability (e.g., absence of drifting) data

### Construct and Train Classification and Prediction Models

Exemplary embodiments may provide machine learning models configured to perform two different functions: classification and prediction.

The classification paradigm is to take a record of data (e.g., a recent time series of data from the instrument) and identify any problems with it. The models will use the signal to determine:
1. Whether there is a problem or not (i.e., classify the signal as either normal or abnormal behavior)
2. What the root cause of the problem is (i.e., classify the problem in a category that has an actionable fix, such as a valve leak)
3. Predict when future failures might occur (e.g., remaining usable life of a part, or the amount of time it takes to equilibrate the instrument for the next injection)

Building on a model that classifies the pressure signal as equilibrated or not for reverse-phase injections, further models may be built that:
1. Indicate equilibration of injections
2. Indicate loss of prime
3. Indicate regaining of prime
4. Indicate that there is a leak and the cause of the leak is the check valve

Exemplary embodiments may extract data from an analytical chemistry device (e.g., an LC device) at a rate of at least 10 Hz; in some cases, the analytical chemistry device may natively provide diagnostic data at this rate. Using at least a 10 Hz rate may improve the successful diagnosis of error states.

An application may read 96-hour plot files, where the 10 Hz data is written to by the analytical chemistry device firmware. In one embodiment, the following steps may be performed by a computer processor:
Call on an instrument API, and use it to read the binary 96-hour-plot data
Embed this new code in the appropriate location in edge device code so that it can be used by the pipeline
Call this code from a microapp for gathering feedback on out equilibration model

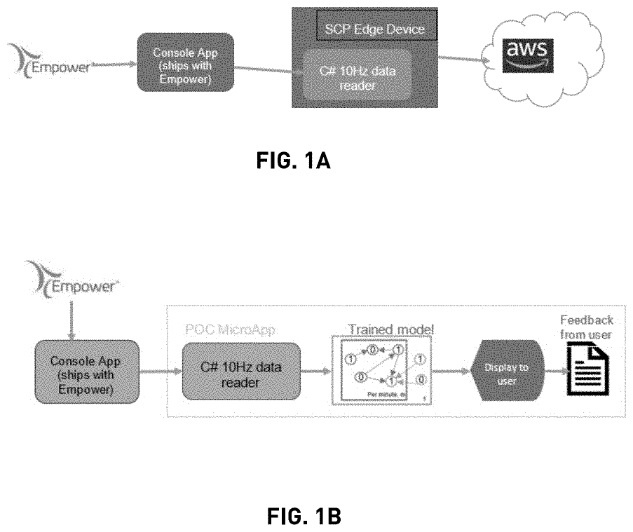

FIG. 1A depicts an example of this step.

### Develop an Equilibration Microapp

The microapp may be a web app of a thick client that will use suitable code to read the (at least) 10 Hz data, employ the already trained model to determine time of equilibration, present the equilibration time to the user, and garner feedback from the user on whether the model was correct, early or late. The code may also extract considerable amounts of metadata regarding the compositions of solvents, flow rate, etc, in order to define the context for the performance of the model. The microapp can be written in python using a low code library for generating web apps, or simple GUI libraries if creating a thick client.

FIG. 1B depicts an example of this step.

Many test cases may be generated for each of the situations to be solved for, such as priming, equilibration and leaks. The performance of the model(s) may be compared against a human subject matter expert. Any relevant metrics for calculating the performance of the model against the human may be used, such as correlation, RMSE, accuracy, etc.

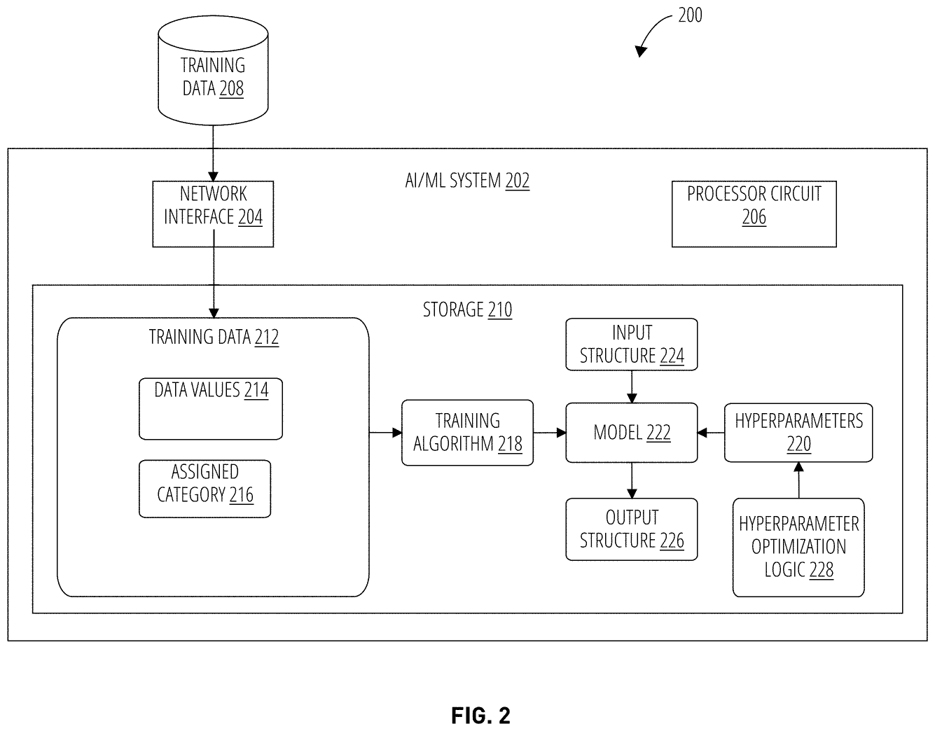

Exemplary embodiments may make use of artificial intelligence/machine learning (AI/ML). FIG. 2 depicts an AI/ML environment 200 suitable for use with exemplary embodiments.

At the outset it is noted that FIG. 2 depicts a particular AI/ML environment 200 and is discussed in connection with particular types of AI/ML architectures. However, other AI/ML systems also exist, and one of ordinary skill in the art will recognize that AI/ML environments other than the one depicted may be implemented using any suitable technology.

The AI/ML environment 200 may include an AI/ML System 202, such as a computing device that applies an AI/ML algorithm to learn relationships between the above-noted protein parameters.

The AI/ML System 202 may make use of training data 208. In some cases, the training data 208 may include pre-existing labeled data from databases, libraries, repositories, etc. The training data 208 may include, for example, rows and/or columns of data values 214. The training data 208 may be collocated with the AI/ML System 202 (e.g., stored in a Storage 210 of the AI/ML System 202), may be remote from the AI/ML System 202 and accessed via a Network Interface 204, or may be a combination of local and remote data. Each unit of training data 208 may be labeled with an assigned category 216 (or multiple assigned categories); for instance, each row and/or column may be labeled with a classification. In some embodiments, the training data may include individual data elements (e.g., not organized into rows or columns) and may be labeled on an individual basis.

As noted above, the AI/ML System 202 may include a Storage 210, which may include a hard drive, solid state storage, and/or random access memory.

The Training Data 212 may be applied to train a model 222. Depending on the particular application, different types of models 222 may be suitable for use. For instance, exemplary embodiments may make use of Bayesian hierarchical models or gradient boosted trees may be particularly well-suited to learning associations the data values 214 and the assigned category 216. In other examples, an deep learning architectures such as a recurrent neural network (RNN). Other types of models 222, or non-model-based systems, may also be well-suited to the tasks described herein, depending on the designers goals, the resources available, the amount of input data available, etc.

Any suitable Training Algorithm 218 may be used to train the model 222. Nonetheless, the example depicted in FIG. 2 may be particularly well-suited to a supervised training algorithm. For a supervised training algorithm, the AI/ML System 202 may apply the data values 214 as input data, to which the resulting assigned category 216 may be mapped to learn associations between the inputs and the labels. In this case, the assigned category 216 may be used as a labels for the data values 214.

The Training Algorithm 218 may be applied using a Processor Circuit 206, which may include suitable hardware processing resources that operate on the logic and structures in the Storage 210. The Training Algorithm 218 and/or the development of the trained model 222 may be at least partially dependent on model Hyperparameters 220; in exemplary embodiments, the model Hyperparameters 220 may be automatically selected based on Hyperparameter Optimization logic 228, which may include any known hyperparameter optimization techniques as appropriate to the model 222 selected and the Training Algorithm 218 to be used.

Optionally, the model 222 may be re-trained over time.

In some embodiments, some of the Training Data 212 may be used to initially train the model 222, and some may be held back as a validation subset. The portion of the Training Data 212 not including the validation subset may be used to train the model 222, whereas the validation subset may be held back and used to test the trained model 222 to verify that the model 222 is able to generalize its predictions to new data.

Once the model 222 is trained, it may be applied (by the Processor Circuit 206) to new input data. The new input data may include unlabeled data stored in a data structure, potentially organized into rows and/or columns. This input to the model 222 may be formatted according to a predefined input structure 224 mirroring the way that the Training Data 212 was provided to the model 222. The model 222 may generate an output structure 226 which may be, for example, a prediction of an assigned category 216 to be applied to the unlabeled input.

The above description pertains to a particular kind of AI/ML System 202, which applies supervised learning techniques given available training data with input/result pairs. However, the present invention is not limited to use with a specific AI/ML paradigm, and other types of AI/ML techniques may be used.

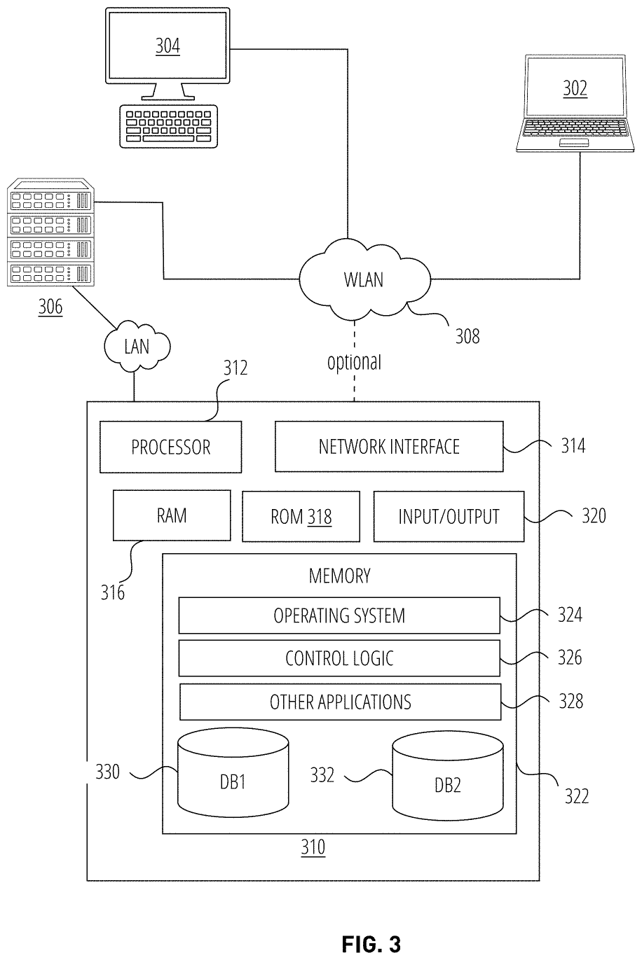

FIG. 3 illustrates one example of a system architecture and data processing device that may be used to implement one or more illustrative aspects described herein in a standalone and/or networked environment. Various network nodes, such as the data server 310, web server 306, computer 304, and laptop 302 may be interconnected via a wide area network 308 (WAN), such as the internet. Other networks may also or alternatively be used, including private intranets, corporate networks, LANs, metropolitan area networks (MANs) wireless networks, personal networks (PANs), and the like. Network 308 is for illustration purposes and may be replaced with fewer or additional computer networks. A local area network (LAN) may have one or more of any known LAN topology and may use one or more of a variety of different protocols, such as ethernet. Devices data server 310, web server 306, computer 304, laptop 302 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 310, web server 306, and client computer 304, laptop 302. Data server 310 provides overall access, control and administration of databases and control software for performing one or more illustrative aspects described herein. Data serverdata server 310 may be connected to web server 306 through which users interact with and obtain data as requested. Alternatively, data server 310 may act as a web server itself and be directly connected to the internet. Data server 310 may be connected to web server 306 through the network 308 (e.g., the internet), via direct or indirect connection, or via some other network. Users may interact with the data server 310 using remote computer 304, laptop 302, e.g., using a web browser to connect to the data server 310 via one or more externally exposed web sites hosted by web server 306. Client computer 304, laptop 302 may be used in concert with data server 310 to access data stored therein, or may be used for other purposes. For example, from client computer 304, a user may access web server 306 using an internet browser, as is known in the art, or by executing a software application that communicates with web server 306 and/or data server 310 over a computer network (such as the internet).

Servers and applications may be combined on the same physical machines, and retain separate virtual or logical addresses, or may reside on separate physical machines. FIG. 3 illustrates just one example of a network architecture that may be used, and those of skill in the art will appreciate that the specific network architecture and data processing devices used may vary, and are secondary to the functionality that they provide, as further described herein. For example, services provided by web server 306 and data server 310 may be combined on a single server.

Each component data server 310, web server 306, computer 304, laptop 302 may be any type of known computer, server, or data processing device. Data server 310, e.g., may include a processor 312 controlling overall operation of the data server 310. Data server 310 may further include RAM 316, ROM 318, network interface 314, input/output interfaces 320 (e.g., keyboard, mouse, display, printer, etc.), and memory 322. Input/output interfaces 320 may include a variety of interface units and drives for reading, writing, displaying, and/or printing data or files. Memory 322 may further store operating system software 324 for controlling overall operation of the data server 310, control logic 326 for instructing data server 310 to perform aspects described herein, and other application software 328 providing secondary, support, and/or other functionality which may or may not be used in conjunction with aspects described herein. The control logic may also be referred to herein as the data server software control logic 326. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 332 and a second database 330. In some embodiments, the first database may include the second database (e.g., as a separate table, report, etc.). That is, the information can be stored in a single database, or separated into different logical, virtual, or physical databases, depending on system design. Web server 306, computer 304, laptop 302 may have similar or different architecture as described with respect to data server 310. Those of skill in the art will appreciate that the functionality of data server 310 (or web server 306, computer 304, laptop 302) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

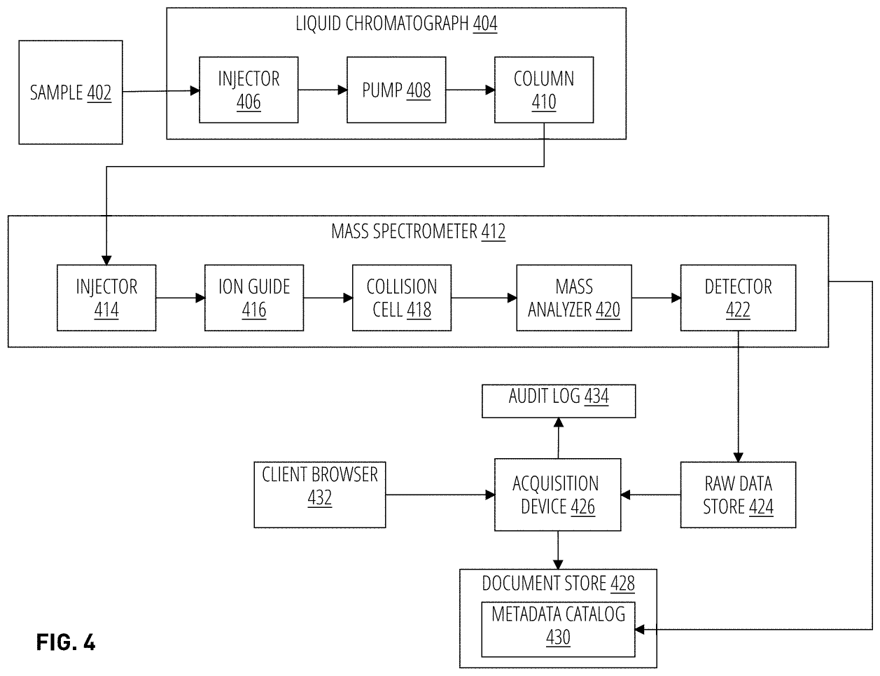

For purposes of illustration, FIG. 4 is a schematic diagram of a system that may be used in connection with techniques herein. Although FIG. 4 depicts particular types of devices in a specific LCMS configuration, one of ordinary skill in the art will understand that different types of chromatographic devices (e.g., MS, tandem MS, etc.) may also be used in connection with the present disclosure.

A sample 402 is injected into a liquid chromatograph 404 through an injector 406. A pump 408 pumps the sample through a column 410 to separate the mixture into component parts according to retention time through the column.

The output from the column is input to a mass spectrometer 412 for analysis. Initially, the sample is desolved and ionized by a desolvation/ionization device 114. Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 418 by a voltage gradient being applied to an ion guide 416. Collision cell 418 can be used to pass the ions (low-energy) or to fragment the ions (high-energy).

Different techniques (including one described in U.S. Pat. No. 6,717,130, to Bateman et al., which is incorporated by reference herein) may be used in which an alternating voltage can be applied across the collision cell 418 to cause fragmentation. Spectra are collected for the precursors at low-energy (no collisions) and fragments at high-energy (results of collisions).

The output of collision cell 418 is input to a mass analyzer 420. Mass analyzer 420 can be any mass analyzer, including quadrupole, time-of-flight (TOF), ion trap, magnetic sector mass analyzers as well as combinations thereof. A detector 422 detects ions emanating from mass analyzer 122. Detector 422 can be integral with mass analyzer 420. For example, in the case of a TOF mass analyzer, detector 422 can be a microchannel plate detector that counts intensity of ions, i.e., counts numbers of ions impinging it.

A raw data store 424 may provide permanent storage for storing the ion counts for analysis. For example, raw data store 424 can be an internal or external computer data storage device such as a disk, flash-based storage, and the like. An acquisition 426 analyzes the stored data. Data can also be analyzed in real time without requiring storage in a storage medium 124. In real time analysis, detector 422 passes data to be analyzed directly to computer 126 without first storing it to permanent storage.

Collision cell 418 performs fragmentation of the precursor ions. Fragmentation can be used to determine the primary sequence of a peptide and subsequently lead to the identity of the originating protein. Collision cell 418 includes a gas such as helium, argon, nitrogen, air, or methane. When a charged precursor interacts with gas atoms, the resulting collisions can fragment the precursor by breaking it up into resulting fragment ions. Such fragmentation can be accomplished as using techniques described in Bateman by switching the voltage in a collision cell between a low voltage state (e.g., low energy, <5 V) which obtains MS spectra of the peptide precursor, with a high voltage state (e.g., high or elevated energy, >15V) which obtains MS spectra of the collisionally induced fragments of the precursors. High and low voltage may be referred to as high and low energy, since a high or low voltage respectively is used to impart kinetic energy to an ion.

Various protocols can be used to determine when and how to switch the voltage for such an MS/MS acquisition. For example, conventional methods trigger the voltage in either a targeted or data dependent mode (data-dependent analysis, DDA). These methods also include a coupled, gas-phase isolation (or pre-selection) of the targeted precursor. The low-energy spectra are obtained and examined by the software in real-time. When a desired mass reaches a specified intensity value in the low-energy spectrum, the voltage in the collision cell is switched to the high-energy state. The high-energy spectra are then obtained for the pre-selected precursor ion. These spectra contain fragments of the precursor peptide seen at low energy. After sufficient high-energy spectra are collected, the data acquisition reverts to low-energy in a continued search for precursor masses of suitable intensities for high-energy collisional analysis.

Different suitable methods may be used with a system as described herein to obtain ion information such as for precursor and product ions in connection with mass spectrometry for an analyzed sample. Although conventional switching techniques can be employed, embodiments may also use techniques described in Bateman which may be characterized as a fragmentation protocol in which the voltage is switched in a simple alternating cycle. This switching is done at a high enough frequency so that multiple high- and multiple low-energy spectra are contained within a single chromatographic peak. Unlike conventional switching protocols, the cycle is independent of the content of the data. Such switching techniques described in Bateman, provide for effectively simultaneous mass analysis of both precursor and product ions. In Bateman, using a high- and low-energy switching protocol may be applied as part of an LC/MS analysis of a single injection of a peptide mixture. In data acquired from the single injection or experimental run, the low-energy spectra contains ions primarily from unfragmented precursors, while the high-energy spectra contain ions primarily from fragmented precursors. For example, a portion of a precursor ion may be fragmented to form product ions, and the precursor and product ions are substantially simultaneously analyzed, either at the same time or, for example, in rapid succession through application of rapidly switching or alternating voltage to a collision cell of an MS module between a low voltage (e.g., generate primarily precursors) and a high or elevated voltage (e.g. generate primarily fragments) to regulate fragmentation. Operation of the MS in accordance with the foregoing techniques of Bateman by rapid succession of alternating between high (or elevated) and low energy may also be referred to herein as the Bateman technique and the high-low protocol.

The data acquired by the high-low protocol allows for the accurate determination of the retention times, mass-to-charge ratios, and intensities of all ions collected in both low- and high-energy modes. In general, different ions are seen in the two different modes, and the spectra acquired in each mode may then be further analyzed separately or in combination. The ions from a common precursor as seen in one or both modes will share the same retention times (and thus have substantially the same scan times) and peak shapes. The high-low protocol allows the meaningful comparison of different characteristics of the ions within a single mode and between modes. This comparison can then be used to group ions seen in both low-energy and high-energy spectra.

In summary, such as when operating the system using the Bateman technique, a sample 402 is injected into the LC/MS system. The LC/MS system produces two sets of spectra, a set of low-energy spectra and a set of high-energy spectra. The set of low-energy spectra contain primarily ions associated with precursors. The set of high-energy spectra contain primarily ions associated with fragments. These spectra are stored in a raw data store 424. After data acquisition, these spectra can be extracted from the raw data store 424 and displayed and processed by post-acquisition algorithms in the acquisition device 426.

Metadata describing various parameters related to data acquisition may be generated alongside the raw data. This information may include a configuration of the liquid chromatograph 404 or mass spectrometer 412 (or other chromatography apparatus that acquires the data), which may define a data type. An identifier (e.g., a key) for a codec that is configured to decode the data may also be stored as part of the metadata and/or with the raw data. The metadata may be stored in a metadata catalog 430 in a document store 428.

The acquisition device 426 may operate according to a workflow, providing visualizations of data to an analyst at each of the workflow steps and allowing the analyst to generate output data by performing processing specific to the workflow step. The workflow may be generated and retrieved via a client browser 432. As the acquisition device 426 performs the steps of the workflow, it may read raw data from a stream of data located in the raw data store 424. As the acquisition device 426 performs the steps of the workflow, it may generate processed data that is stored in a metadata catalog 430 in a document store 428; alternatively or in addition, the processed data may be stored in a different location specified by a user of the acquisition device 426. It may also generate audit records that may be stored in an audit log 434.

The exemplary embodiments described herein may be performed at the client browser 432 and acquisition device 426, among other locations.

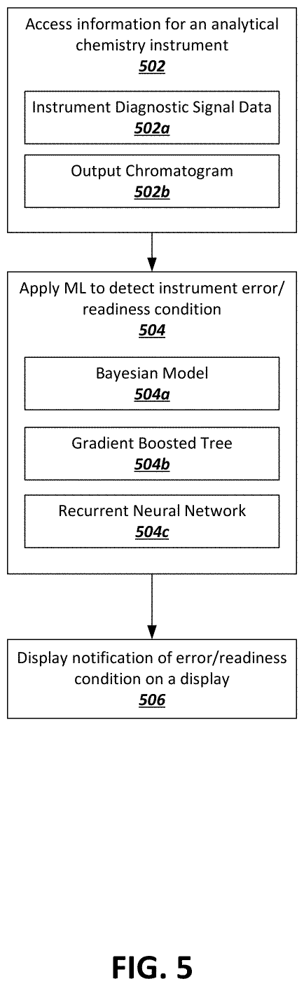

FIG. 5 is a flowchart depicting exemplary logic suitable for performing a method for identifying system readiness or error conditions. The logic may be stored as instructions on a non-transitory computer-readable medium and/or executed by one or more processors.

At block 502, information for an analytical chemistry instrument may be accessed. The information may include, for example, instrument diagnostic signal data 502a (such as pressure traces, temperature readings, etc.) and/or one or more output chromatograms 502b generated in response to a request to perform an analysis on a sample. Different types of readiness/error conditions may make use of different types of data; for example, detecting a loss of prime state may rely on pressure traces, whereas detecting an equilibration state may rely on both pressure traces and chromatogram data.

At block 504, machine learning may be applied to detect an instrument error or readiness condition. Machine learning may be used to train a classification and/or prediction model to detect the system readiness/error condition. Examples of models well-suited to use with exemplary embodiments include Bayesian models 504a, gradient boosted trees 504b, and recurrent neural networks 504c. Using these types of models, in some embodiments the readiness/error condition can be detected with only a limited amount of system data (e.g., two minutes' worth of data), which allows for high-speed detection of problems and system readiness conditions.

At block 506, the ML system may display a notification of the error or readiness condition on a display device. In some embodiments, the display may include graphic elements that allow a user to take context-specific action based on the type of error or readiness condition detected. For instance, when a readiness condition such as system equilibration is detected, a selectable element may appear allowing the user to begin a sample analysis run. When an error condition such as a check valve leak is detected, a visual guide may appear describing the problem to the user and showing the user how to fix it.

In some embodiments, the ML system may take automatic action in response to detecting an error or readiness condition—for example, when a readiness condition such as equilibration is detected, the system may automatically begin a queued sample analysis run without requiring further input from the user. When a loss of prime condition is detected, the system may automatically terminate a current analysis run.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method comprising:
accessing information for an analytical chemistry instrument;
applying a machine learning model to the information, the machine learning model configured to detect one or more of an instrument error condition or an instrument readiness condition; and
displaying, on a display, a result of applying the machine learning model to the information, where the result comprises a notification that the error condition or readiness condition has occurred.

2. The computer-implemented method of claim 1, wherein the analytical chemistry instrument is a liquid chromatography (LC) device.

3. The computer-implemented method of claim 1, wherein the information is one or more of instrument diagnostic signal data or a chromatogram generated based on an output of the analytical chemistry instrument.

4. The computer-implemented method of claim 1, wherein the instrument error condition or the instrument readiness condition comprises one or more of a primed/unprimed state, an equilibrated/not equilibrated state, a check valve leak, a pressure seal leak, a degasser failure, a clogged inject valve, a partially clogged needle, a fouled column, a column that is chemically and/or thermally equilibrated, or a detector that is stable and/or not drifting.

5. The computer-implemented method of claim 1, wherein the machine learning model comprises one or more of a Bayesian hierarchical model, a gradient boosted tree, or a recurrent neural network.

6. A non-transitory computer-readable storage medium, the computer-readable storage medium including instructions that when executed by a computer, cause the computer to:
access information for an analytical chemistry instrument;
apply a machine learning model to the information, the machine learning model configured to detect one or more of an instrument error condition or an instrument readiness condition; and
display, on a display, a result of applying the machine learning model to the information, where the result comprises a notification that the error condition or readiness condition has occurred.

7. The computer-readable storage medium of claim 6, wherein the analytical chemistry instrument is a liquid chromatography (LC) device.

8. The computer-readable storage medium of claim 6, wherein the information is one or more of instrument diagnostic signal data or a chromatogram generated based on an output of the analytical chemistry instrument.

9. The computer-readable storage medium of claim 6, wherein the instrument error condition or the instrument readiness condition comprises one or more of a primed/unprimed state, an equilibrated/not equilibrated state, a check valve leak, a pressure seal leak, a degasser failure, a clogged inject valve, a partially clogged needle, a fouled column, a column that is chemically and/or thermally equilibrated, or a detector that is stable and/or not drifting.

10. The computer-readable storage medium of claim 6, wherein the machine learn model comprises one or more of a Bayesian hierarchical model, a gradient boosted tree, or a recurrent neural network.

11. A computing apparatus comprising:
a processor; and
a memory storing instructions that, when executed by the processor, configure the apparatus to:
access information for an analytical chemistry instrument;
apply a machine learning model to the information, the machine learning model configured to detect one or more of an instrument error condition or an instrument readiness condition; and
display, on a display, a result of applying the machine learning model to the information, where the result comprises a notification that the error condition or readiness condition has occurred.

12. The computing apparatus of claim 11, wherein the analytical chemistry instrument is a liquid chromatography (LC) device.

13. The computing apparatus of claim 11, wherein the information is one or more of instrument diagnostic signal data or a chromatogram generated based on an output of the analytical chemistry instrument.

14. The computing apparatus of claim 11, wherein the instrument error condition or the instrument readiness condition comprises one or more of a primed/unprimed state, an equilibrated/not equilibrated state, a check valve leak, a pressure seal leak, a degasser failure, a clogged inject valve, a partially clogged needle, a fouled column, a column that is chemically and/or thermally equilibrated, or a detector that is stable and/or not drifting.

15. The computing apparatus of claim 11, wherein the machine learn model comprises one or more of a Bayesian hierarchical model, a gradient boosted tree, or a recurrent neural network.
